(19) United States
(12) Patent Application Publication
(10) Pub. No.: US 2002/0127911 A1
(43) Pub. Date: Sep. 12, 2002

(54) CONNECTOR COUPLED BY PRESSURE FOR TELECOMMUNICATIONS SYSTEMS

(76) Inventor: UMBERTO DI MARIO, ROME (IT)

Correspondence Address: SMITH GAMBRELL & RUSSELL L.L.P., 1850 M STREET N .W, WASHINGTON, DC, 20036, US

(21) Appl. No.: 09/319,106

(22) PCT Filed: Nov. 29, 1996
(86) PCT No.: PCT/IT96/00236

(51) Int. Cl. H01R 9/05

(52) U.S. Cl. 439/578

(57) ABSTRACT

The invention concerns a coaxial connector (1), particularly for the mechanical and electrical connection of the outer screening conductor (21) of a coaxial cable (20) with the outer screening (41) of a female coaxial connector (40), said coaxial connector (1) comprising a slidable sleeve (1) having a first (2) and a second (3) coaxial inner cylindrical seat, said first seat (2) having an inner diameter (d1) corresponding to or slightly greater than the outer diameter of said cable (20) and said second seat (3) having an inner diameter (d2) slightly greater than the outer diameter of the outer wall (41) of said connector (40), in such a way to obtain a pressure coupling of the coaxial cable (20) screen (21) between the sleeve of coaxial connector (1) and the outer wall (41) of the female coaxial connector (40).

The present invention concerns a sleeve for coaxial connection coupable by pressure for telecommunications systems.

More specifically, the invention concerns an arrangement of a sleeve, a coaxial cable and a female coaxial connector for coaxial connection of the above kind to be employed to couple in a quick and electrically perfect way a coaxial cable with a female coaxial connector, for example provided with an outer thread and a central contact, e.g. an elastic central contact of the F kind connectors.

As it is known, to connect coaxial cables with electrical or electronic circuits, and more particularly for the coaxial connections employed for the realisation of systems for the distribution of radio TV signals, metallic clamps are generally employed, said clamps being cheap but having different technical drawbacks.

The above drawbacks are even more evident if considering that the advancement of the state of the art makes it common the use of signal reception and distribution systems having frequencies higher than 2000 MHz, such as the satellite reception systems, the cable networks, the MMDS systems and so on.

In order to obviate to these drawbacks it is advisable the use of male and female coaxial connectors, the first one couples to the coaxial cable and the other one to the final circuit.

The technique already known generally provides, for the connection of coaxial cables with coaxial connectors, the welding or screwing of the two poles to the cable of the connectors ends, or the screwing or crimping of the male coaxial connector on the screen conductor of the coaxial cable.

Further, the coupling of the cable with a connector is realised by screwing or by coupling or introduction of two metallic parts, a rigid one and an elastic one, respectively.

On the basis of these solutions, all the past and present systems, patented or not, and all the commercial coaxial connectors have been developed.

The choice of this kind of solution for the coupling of coaxial cables is due to the limited use of the coaxial joints employed or professional apparatuses only, highly expensive with respect to the cost of one or two traditional coaxial joints.

The most updated technological development has instead greatly widened the fields of use of the coaxial cables and consequently of the relevant connectors which, if employed for uses such as the radio frequencies distribution in the domestic buildings, highly influence the cost of the work necessary to obtain a technically efficient but cheap and easy to apply coupling.

Within this general situation, it is included the solution suggested according to the present invention which is able to satisfy the above needing, being completely different with respect to the systems already employed.

Main object of the present invention is that of obtaining a sleeve of coaxial connection allowing to realise a coupling between a coaxial cable and a female coaxial connector so as to obtain, within a frequencies range between 0 and more the 2000 MHz, a constant impedance power transfer, with maximum concentricity, maximum electromagnetic screening, minimum loss of the signal, minimum mismatching and minimum parasitic capacitance.

It is a further objection of the present invention that of realising a sleeve for coaxial connection allowing a connection between a coaxial cable and a female coaxial connector having a good mechanical coupling but which is at the same time easily removable.

A further object of the invention is that of realising a sleeve for coaxial connection allowing a connection between a coaxial cable and a female coaxial connector very easy to be realised, to be used without the need of an specific tool, with minimum sized and very cheap.

These and other results are obtained according to the present invention suggesting a sleeve for coaxial connection coupable by pressure for telecommunication systems employing as central pin of the connection the rigid central conductor of the coaxial cable fixed by pressure on the outer surface of the female connector by a sleeve slicable on the cable and having on its rear portion a diameter corresponding to or slightly greater than the diameter of the coaxial cable and on its front portion a diameter slightly greater than the one of the outer surface of the female connector.

It is therefore specific object of the present invention an arrangement of a sleeve a coaxial cable and a female coaxial connector suitable for coaxial connection, particularly for the mechanical and electrical connection of the outer screening conductor of the coaxial cable with the outer wall of the female coaxial connector, said female coaxial connector being of the kind providing a substantiality cylindrical outer wall and an inner, insulated central female contact, characterised in that said sleeve has a first and a second coaxial inner cylindrical seat, said first seat having an inner diameter (d1) corresponding to or slightly greater than the outer diameter of said cable and said second seat having an inner diameter (d2) slightly greater than the outer diameter of the outer wall of said female connector, and being realised by an elastic material, in such a way to obtain a pressure coupling of the outer screening conductor of the coaxial cable between the sleeve and the outer wall of the female coaxial connector, the connection zone between said first and second seats being realised by a sloped wall.

Preferably, according to the invention, at least one projection can be provided within said second seat.

Furthermore, according to the invention, outside said second seat, close to the outer connection zone with said first seat, a circular projection can be provided.

Still according to the invention, spaced longitudinal ribs can be provided outside said second seat.

Always according to the invention, on the inner surface of said first and second seat a roughness can be provided.

Within said first seat, longitudinal lugs can be further provided, preferably three lugs circumferentially spaced at 120°.

Always according to the invention, said sleeve for coaxial connection is used for the connection of the coaxial cable screen made up of metallic braid, with the threaded outer screening of a female coaxial connection, or it is used for the connection of the coaxial cable screen made up of one or more metallic foils, with the threaded outer screening of a female coaxial cable, or still for the connection of the coaxial cable screen, made up of metallic braid and one or more metallic foils, with the outer screening of a female coaxial connector.

Furthermore, according to the invention, said sleeve for coaxial connection can be made up with plastic material, elastic material, such as rubber, or elastic metallic material.

The present invention will be now described, for illustrative but not limitative purposes, according to its preferred embodiments, with particular reference to the figure of the enclosed drawings, wherein:

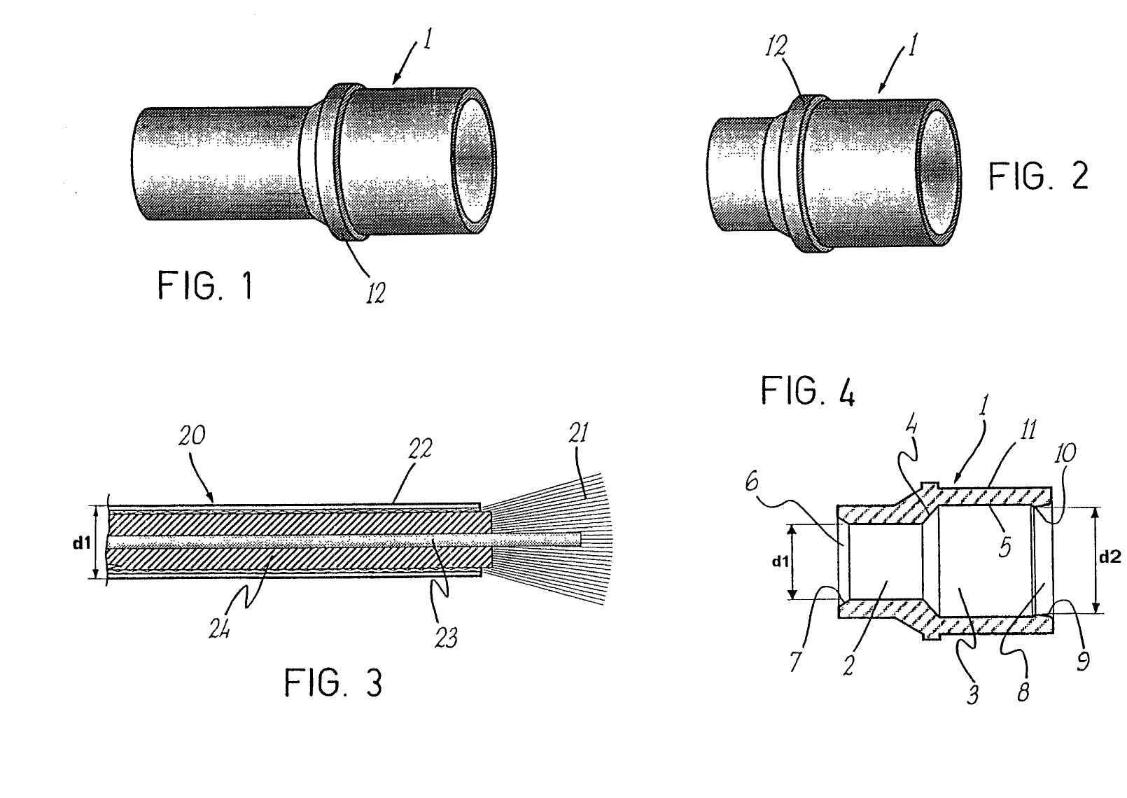

FIG. 1 is a perspective view of a first embodiment of a sleeve for coaxial connection according to the invention;

FIG. 2 is a perspective view of a second embodiment of a sleeve for coaxial connection, according to the invention;

FIG. 3 is a section lateral view of the head of the coaxial cable ready for the connection;

FIG. 4 is a section view of a sleeve for coaxial connection, according to the invention;

FIG. 5 is a section view of the coaxial cable, of the sleeve for coaxial connection and of the female coaxial connector of the F kind ready for the realisation of the coaxial connection;

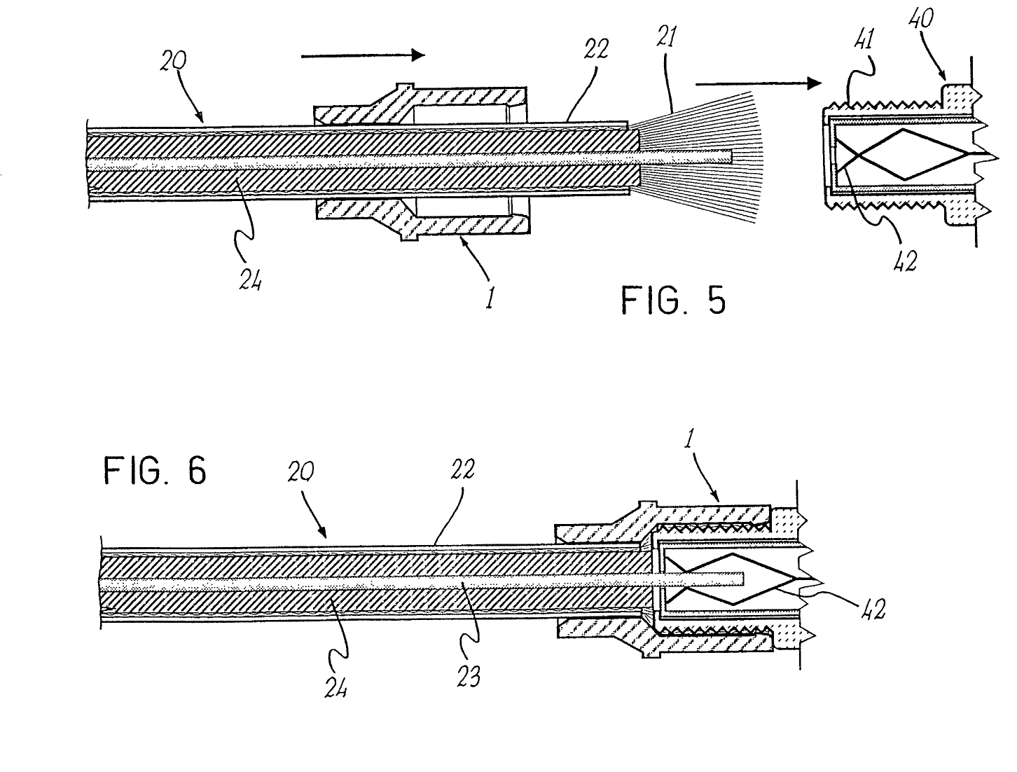

FIG. 6 is a section view of a connection of a coaxial cable with a female coaxial connector of the F kind realised employing the sleeve for coaxial connection according to the invention; and

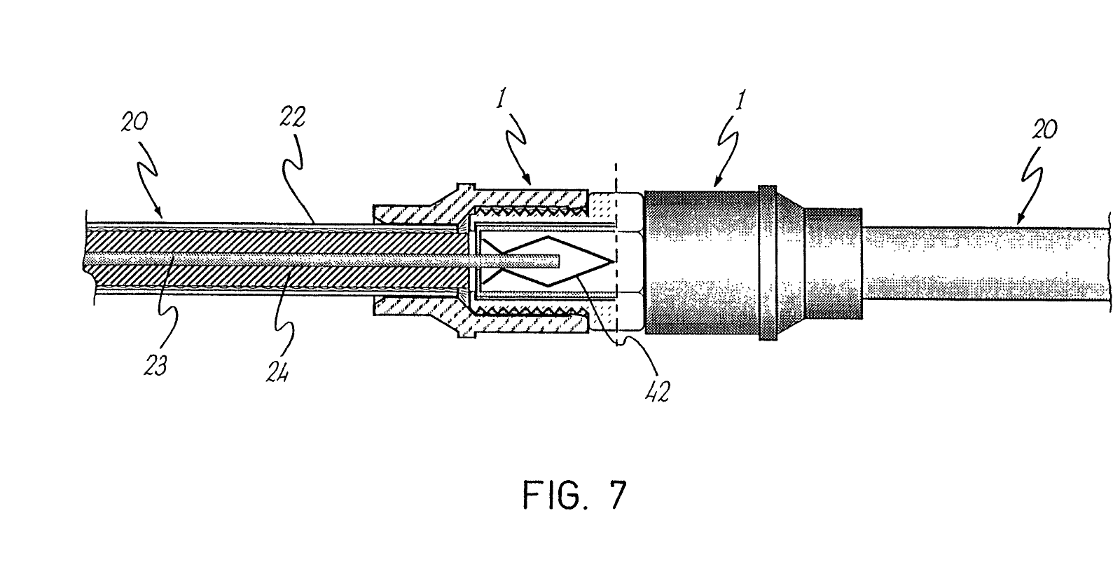

FIG. 7 is a partially sectioned view of a connection between two cables realised employing two sleeve for coaxial connection according to the invention and a double female coaxial connector of the F kind.

Making reference to the figures of the drawings enclosed, the slidable sleeve for coaxial connection 1 according to the present invention is comprised of an integral body of material preferably semi rigid or elastic, in the hollow inner part of which two coaxial cylindrical seats 2, 3 are obtained, said seats being connected by a sloped wall 4, and having the inner smaller diameter d1 corresponding to or greater than the outer diameter of the coaxial cable 20 used for the connection and the bigger inner diameter d2 slightly bigger than the outer diameter of the threaded surface or wall 41 of the coaxial connector 40 in order to allow to fix the screen 21 of the coaxial cable 20 between the threaded outer surface 41 of the coaxial connector 40 and the inner surface 5 having the diameter d2 of the slidable sleeve for coaxial connection.

The cylindrical portion 2 of the sleeve for coaxial connection wounding the coaxial cable 20 is quite long, as shown in FIG. 1, in order to obtain a greater mechanical stability for the connection, or shorter, as shown in FIG. 2, to realise a connection in limited spaces, such as the embedded boxes for the fittings of the distribution systems of the radio TV signals.

The inner surfaces of the sleeve for coaxial connection 1 according to the invention can be rough in order to increase the adherence of the sleeve for coaxial connection 1 with the outer sheath 22 of the coaxial cable 20 and with the threaded outer surface or wall 41 of the female coaxial connector 40. The circular opening 6 of the sleeve for coaxial connection 1 having diameter d1 ends with a flared part 7 making it easier the insertion of the sleeve for coaxial connection 1 on the terminal of the coaxial cable 20.

The circular opening 8 of the sleeve for coaxial connection 1 having the diameter d2 ends with the flared portion 9 making it easier the insertion of the sleeve for coaxial connection on the female coaxial connector 40.

For particular uses the slidable sleeve sleeve for coaxial connection 1 can be provided in the inner part with projections 10 making it much more difficult the removal of the female coaxial connector 40.

The thickness of the slidable sleeve coaxial connector is a function of the dimensions of the coaxial cable 20 to be connected and of the material employed for the realisation of the sleeve for coaxial connection 1. The outer wall 11 of the slidable sleeve for coaxial connection 1 has circumferencial ridge 12 to make it easier, by creating a grip upon which it is possible to exert a higher pressure with the hands, during the insertion and removal operations of the slidable sleeve for coaxial connection 1 from the female coaxial connector 40.

Lugs (not shown) can be provided within the seat 2, preferably three lugs at 120°, to avoid the sliding of the sleeve for coaxial connection 1 along cables having smaller diameter.

The use of the slidable sleeve for coaxial connection 1 as described is particularly simple:

as first step, the sleeve for coaxial connection 1 is introduced from the part with the smaller diameter d1 on the terminal of the coaxial cable 20 to be connected;

then, the coaxial cable 20 is suitable prepared as shown in FIG. 3, widening the screen 21 of the same cable and obtaining the situation shown in FIG. 5;

now the central conductor 23 of the coaxial cable 20 within the central tap 42 of the female coaxial connector 40;

finally, the sleeve for coaxial connection 1 slides along the coaxial cable 20 toward the female connector 40 up to the complete coupling with the threaded outer surface or wall 41 of the connector 40 with the sleeve for coaxial connection 1, as shown in FIG. 6: by this step, the seen 21 of the coaxial cable 20 is automatically lied an and lightened on the threaded outer surface or wall 41 of the female coaxial connector 40 at the same time obtaining the double mechanical and electrical coupling between the cable 20 and the connector 40.

From the description of the coaxial coupling obtained by the solution according to the present invention, the advantages that said coaxial slidable sleeve for coaxial connection 1 allows to obtain with respect to the known coaxial connection systems are quite evident.

It is in fact evident, the ease and the convenience of use of the solution according to the invention, which can be set up without employing any tool but the one necessary to strip the coaxial cable 20.

Further, the electrical features of the coaxial coupling are optimal; the concentricity and the complete screening of the connection are ensured by the immediate electric contact between the cable screen 21 and the outer surface or wall 41 of the connector 40, contact obtained immediately after the screen 21 of the coaxial cable 20 is widened and detached from the dielectric 24 dividing the same screen 21 from the central conductor 23 of the coaxial cable 20.

These features allow to have a perfect working of the coaxial connection within a frequencies range between 0 and more than 2000 MHz.

The sleeve for coaxial connection 1 according to the invention further allows to make coaxial connection within small spaces, such as the space available within the usual connection blocks of the radio TV signal distribution systems provides within the houses.

The further remarkable advantage is due to the low total cost of the coaxial connection that such a connector allows to realise, cost obtained addition the cost for the material of the connector with the cost of the labour necessary for the realisation of the connection; as it is evident from the above specification of the solution according to the invention and of its use, both costs are very low and in any case lower than the costs necessary to make a valid coaxial connection employing different connectors.

The cable 20 can freely rotate about the central axis of the connector also after the coupling.

Further, the sleeve for coaxial connection 1 according to the invention completely covers the connector, protecting the same.

Another advantage is due to the fact that the sleeve for coaxial connection 1 according to the invention can be used more than once in case it is necessary to make the connection again.

Moreover, the squeezing cf the cable does not occur, squeezing instead occurring with the other solutions of the prior art.

All the above mentioned advantages are such to make the present invention advantageously usable in any application involving the coupling of coaxial cables.

The present invention has been described for illustrative but not limitative purposes, according to its preferred embodiments, but it is to be understood that modifications and/or changes can be introduced by those skilled in the art without departing from the relevant scope as defined in the enclosed claims

1. Arrangement of a sleeve (1) a coaxial cable (20) and a female coaxial connector (40) suitable for coaxial connection, particularly for the mechanical and electrical connection of the outer screening conductor (21) of the coaxial cable (20) with the outer wall (41) of the female coaxial connector (40), said female coaxial connector (40) being of the kind providing a substantially cylindrical outer wall and an inner, insulated central female contact, characterised in that said sleeve (1) had a first (2) and a second (3) coaxial inner cylindrical seat, said first seat (2) having an inner diameter (d1) corresponding to or slightly greater than the outer diameter of said cable (20) and said second seat (3) having an inner diameter (d2) slightly greater than the outer diameter of the outer wall (41) of said female connector (40), and being realised by an elastic material, in such a way to obtain a pressure coupling of the outer screening conductor of the coaxial cable (20) between the sleeve (1) and the outer wall (41) of the female coaxial connector (40), the connection zone between said first and second seats being realised by a sloped wall.

2. Arrangement according to claim 1, characterised in that at least one projection (10) is provided within said second seat (3).

3. Arrangement according to one of the preceding claims characterised in that outside said second seat, close to the outer connection zone with said first seat, a circumferential projection (12) is provided.

4. Arrangement according to one of the preceding claims, characterised in that spaced longitudinal ribs are provided outside said second seat.

5. Arrangement according to one of the preceding claims, characterised in that on the inner surface of said first and second seat a roughness is provided.

6. Arrangement according to one of the preceding claims, characterised in that within said first seat, longitudinal lugs are provided, preferably three lugs circumferentially spaced at 120°.

7. Arrangement according to one of the preceding claims, characterised in that within said second seat, longitudinal lugs are further provided preferably three lugs circumferentially spaced at 120°.

8. Arrangement according to on of the preceding claims characterised in that said sleeve (1) is used for the connection of the outer screening conductor (21) of the coaxial cable (20) made up of metallic braid, with the outer wall (41) of a female coaxial connector (40).

9. Arrangement according to the one of the preceding claims 1-8, characterised in that said sleeve (1) is used for the connection of the outer screening conductor (21) of the coaxial cable (20) made up of one or more metallic foils, with the outer wall (41) of a female coaxial connector (40).

10. Arrangement according to one of the preceding claims 1-8, charcterised in that said sleeve (1) is used for the connection of the outer screening conductor (21) of the coaxial cable (20), made up of metallic braid and one or more metallic foils, with the outer wall (41) of a female coaxial connector (40).

11. Arrangement according to one of the preceding claims, characterised in that said sleeve (1) is made up with plastic material.

12. Arrangement according to one of the preceding claims 1-11 characterised in that said sleeve (1) is made up with elastic material, such as rubber.

13. Arrangement according to one of the preceding claims 1-11, characterised in that said sleeve (1) is made up with elastic metallic material.

14. Method for joining a cable directly onto a female connector by using a sleeve (1) having a first and a second coaxial inner cylindrical seat, said first seat having an inner diameter (d1) corresponding to or slightly greater than the outer diameter of said cable and said second seat having an inner diameter (d2) slightly greater than the outer diameter of the outer wall of said female connector, and being realised by an elastic material, in such a way to obtain a pressure coupling of the outer screening conductor of the coaxial cable between the sleeve and the outer wall of the female coaxial connector, connection zone between said first and second seats is realised by a sloped wall.
